(19) United States
(12) Patent Application Publication
(10) Pub. No.: US 2009/0022294 A1
(43) Pub. Date: Jan. 22, 2009

(54) METHOD AND DEVICE FOR QUIET CALL

(75) Inventors: Steven Wayne Goldstein, Delray Beach, FL (US); John Usher, Montreal (CA); Marc Andre Boillot, Plantation, FL (US)

Correspondence Address: GREENBERG TRAURIG, LLP, 2101 L Street, N.W., Suite 1000, Washington, DC, 20037, US

(73) Assignee: PERSONICS HOLDINGS INC., Boca Raton, FL (US)

(21) Appl. No.: 12/123,129

(22) Filed: May 19, 2008

Related U.S. Application Data
(60) Provisional application No. 60/938,695, filed on May 17, 2007.

(51) Int. Cl. H04M 3/42; H04R 1/10

(52) U.S. Cl. 379/207.02; 381/74

(57) ABSTRACT

At least one exemplary embodiment is directed to an earpiece and method for call control is provided. The method includes receiving an incoming call from a caller, accepting the incoming call in a subscriber non-speech mode, receiving and presenting speech communication from the caller, and responding to the speech communication to a subscriber by way of non-spoken subscriber response messages. The Subscriber can respond to the caller via text-to-speech messages by way of a keypad. The subscriber non-speech mode permits a non-spoken communication dialogue from the Subscriber to the Caller. A first method alerts a subscriber of an incoming call, and a second method permits the Subscriber to respond. Other embodiments are disclosed.

### CROSS REFERENCE TO RELATED APPLICATIONS

This Application is a Non-Provisional and claims the priority benefit of Provisional Application No. 60/938,695 filed on May 17, 2007, the entire disclosure of which is incorporated herein by reference in it's entirety.

### FIELD

The present invention pertains to sound processing and audio management using earpieces, and more particularly though not exclusively, to a device and method for controlling operation of an earpiece and permitting a subscriber to communicate with a caller via non-speech means.

### BACKGROUND

Voice communication exchange between two parties generally involves the transfer of information from a first party to a second, with minimal exchange of information from the second party to the first party. The second party may generally respond to the first party in simple terms such as “yes”, “no”, and “maybe.”

Moreover, a large proportion of communication exchanges received by a person today occur when the person is in a meeting with other people or in a public place, and it is thus difficult for the person to respond to the call without leaving the room or public place (e.g., opera) rejecting the incoming voice communication.

### SUMMARY

At least one exemplary embodiment is directed to a method and device for facilitating communication exchange and call control in using non-speech communications.

In at least a first exemplary embodiment is directed to a method for call control can include the steps of receiving an incoming call from a caller, accepting the incoming call in a subscriber non-speech mode, and communicating a subscriber response message to the caller. The subscriber non-speech mode can permit a non-spoken communication dialogue between the subscriber receiving the incoming call and the caller. A subscriber response message can include sending a text message, synthesized speech voice, or a pre-recorded utterance to the caller by way of keypad entry. Alternatively, a subscriber response message can include performing a call control responsive to detecting a non-speech sound, for instance, sending an automated reply, a call-back time, a busy status, a time-to-hold status, or a termination status.

The method can include alerting the subscriber to the incoming call, and accepting or rejecting the incoming call based on at least one predetermined criteria, for instance, whether the subscriber and caller have previously made a telephone communication, or whether a particular operating mode is enabled to automatically answer the call from the caller. The predetermined criteria can include recognizing a caller identification number listed in a contact list, and accepting the incoming call if the caller identification number is in the contact list.

The method can include determining a priority of the incoming call, and comparing the priority to a predetermined priority threshold for accepting the incoming call. For instance, the caller can be requested to enter the priority in a numerical keypad to produce a priority level, or say a priority as a spoken utterance that can be converted to a priority level. The subscriber can be alerted to the caller and the associated priority level.

The subscriber can be alerted to the incoming call by playing a name of the caller to the subscriber upon receiving the incoming call. The name of the caller can be obtained by comparing a caller Identification to a contact list, and synthesizing the name based on a recognized association of the caller identification to the name. The caller can be prompted for their name, which can be recorded and played to the subscriber. In another arrangement, an audible ring-tone associated with the caller, or their name, can be played to the subscriber upon receiving the incoming call. A volume, pitch, duration, or frequency content of the audible ring-tone can be adjusted based on the determined priority of the incoming call.

In a second exemplary embodiment, a method for call control suitable for use with an earpiece can include receiving an incoming call from a caller, accepting the incoming call in a subscriber non-speech mode, receiving and presenting speech communication from the caller, and responding to the speech communication by way of non-spoken subscriber response messages. The subscriber non-speech mode permits a non-spoken communication dialogue from the subscriber receiving the incoming call to the caller. The method can include alerting the subscriber to the incoming call, and accepting the incoming call upon recognizing an identity or phone number of the caller, determining that the caller is in an approved contact list, or determining if the incoming call is a follow-up to a subscriber call. In another arrangement, the subscriber can be alerted to a caller message upon detecting the caller message, for example, a voice mail, email, or appointment.

Upon accepting the call, ambient sound that otherwise passes through the earpiece to the subscriber's ear canal, can be attenuated to permit the user to hear primarily the speech communication from the caller. This allows the subscriber to more effectively hear the call by isolating the subscriber from the environmental sounds. The user can adjust the volume of the speech communication by non-speech means, such as keypad entry, or the generation of non-speech sounds. The subscriber can listen to the caller and then respond with one or more subscriber response messages without speaking back to the caller. For instance, the subscriber can respond to the caller with text-to-speech messages generated by way of keypad entry.

In a third exemplary embodiment, an earpiece for call control can include a microphone configured to capture sound, a speaker to deliver sound to an ear canal, and a processor operatively coupled to the microphone and the speaker. The processor can analyze an incoming call from a caller and accept the incoming call in a subscriber non-speech mode. The earpiece can include a transceiver operably coupled to the processor to transmit the subscriber response message to the caller responsive to receiving the incoming call. The subscriber non-speech mode permits a non-spoken communication dialogue between the caller and a subscriber that receives the incoming call.

The processor upon receiving a user directive by way of keypad entry can send a text message to the caller to permit the subscriber to respond to the caller without speaking. The processor can attenuate audio content playback that is music, voice mail, or voice messages when presenting speech communication from the caller. The processor can adjust one or more gains of the microphone and speaker to enhance the speech communication received from the caller.

The earpiece can include a text-to-speech module communicatively coupled to the processor to translate the subscriber response message to a synthesized voice message that is delivered or played to the caller. In one arrangement, the microphone can be an Ambient Sound Microphone (ASM) configured to capture ambient sound. The processor can limit ambient sound pass-through to the speaker responsive to accepting the incoming call. In another arrangement, a second microphone can be an Ear Canal Microphone (ECM) configured to capture internal non-speech sound in the ear canal. The processor can detect a non-speech sound, such as a guttural noise, cough, tongue click, or teeth click from the subscriber, and associate the non-speech sound with a call control, for instance to transmit the subscriber response message, or terminate the call.

### BRIEF DESCRIPTION OF THE DRAWINGS

FIG. 1 is a pictorial diagram of an earpiece in accordance with an exemplary embodiment;

FIG. 2 is a block diagram of the earpiece in accordance with an exemplary embodiment;

FIG. 3 is a block diagram for call control in accordance with an exemplary embodiment;

FIG. 4 is a flowchart for a method to alert a subscriber of an incoming call in accordance with an exemplary embodiment; and

FIG. 5 is a flowchart for a method to respond to a caller communication in accordance with an exemplary embodiment.

### DETAILED DESCRIPTION

The following description of at least one exemplary embodiment is merely illustrative in nature and is in no way intended to limit the invention, its application, or uses.

Processes, techniques, apparatus, and materials as known by one of ordinary skill in the relevant art may not be discussed in detail but are intended to be part of the enabling description where appropriate, for example the fabrication and use of transducers.

In all of the examples illustrated and discussed herein, any specific values, for example the sound pressure level change, should be interpreted to be illustrative only and non-limiting. Thus, other examples of the exemplary embodiments could have different values.

Note that similar reference numerals and letters refer to similar items in the following figures, and thus once an item is defined in one figure, it may not be discussed for following figures.

Note that herein when referring to correcting or preventing an error or damage (e.g., hearing damage), a reduction of the damage or error and/or a correction of the damage or error are intended.

Exemplary embodiments herein are directed to a method of Quiet Call between a Subscriber earpiece, or mobile communication device, and a Caller. The method of Quiet Call allows for communication when the Subscriber is in an environment where normal speech communication is undesirable, such as a meeting. The Caller can use either text or conventional speech means to propose questions to the Subscriber, which the Subscriber can respond to using either a text message with the mobile communication device, or using non-speech sounds such as guttural noises, clicks, teeth chatter, or coughs. The non-speech sounds generated by the Subscriber may be converted into a second text or voice message using a sound recognition program, and this second message transmitted back to the Caller. Additional exemplary embodiments can include stored audio messages that a processor associates with non-speech sounds, and then sends the associated stored audio message to the Caller.

In addition to the method of Quiet Call, an earpiece device acclimatization method is described, whereby a user can become slowly acclimatized to different functionality of the earpiece.

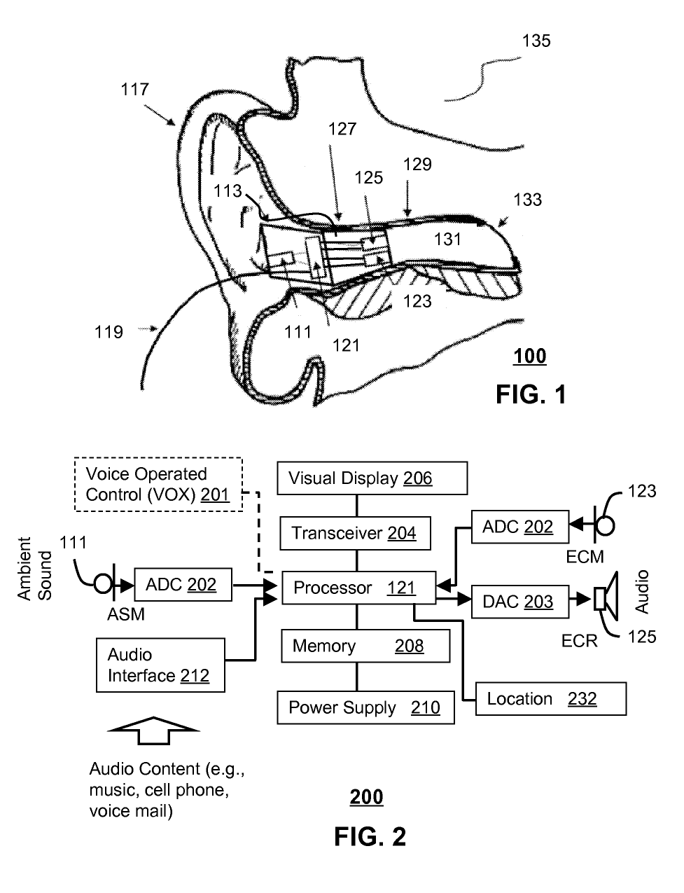

Reference is made to FIG. 1 in which the earpiece device, generally indicated as earpiece 100, is constructed and operates in accordance with at least one exemplary embodiment of the invention. As illustrated, earpiece 100 depicts an electro-acoustical assembly 113 for an in-the-ear acoustic assembly, as it would typically be placed in the ear canal 131 of a user 135. The earpiece 100 can be an in the ear earpiece, behind the ear earpiece, receiver in the ear, open-fit device, or any other suitable earpiece type. The earpiece 100 can be partially or fully occluded in the ear canal, and is suitable for use with users having healthy or abnormal auditory functioning.

Earpiece 100 includes an Ambient Sound Microphone (ASM) 111 to capture ambient sound, an Ear Canal Receiver (ECR) 125 to deliver audio to an ear canal 131, and an Ear Canal Microphone (ECM) 123 to assess a sound exposure level within the ear canal. The earpiece 100 can partially or fully occlude the ear canal 131 to provide various degrees of acoustic isolation. The assembly is designed to be inserted into the user's ear canal 131, and to form an acoustic seal with the walls of the ear canal at a location 127 between the entrance to the ear canal and the tympanic membrane (or ear drum) 133. Such a seal is typically achieved by means of a soft and compliant housing of assembly 113. Such a seal can create a closed cavity 131 of about less than 3 cc between the in-ear assembly 113 and the tympanic membrane 133. As a result of this seal, the ECR (speaker) 125 is able to generate a full range bass response when reproducing sounds for the user. This seal also serves to significantly reduce the sound pressure level at the user's eardrum resulting from the sound field at the entrance to the ear canal 131. This seal is also a basis for a sound isolating performance of the electro-acoustic assembly.

Located adjacent to the ECR 125, is the ECM 123, which is acoustically coupled to the (closed or partially closed) ear canal cavity 131. One of ECM 123 functions is that of measuring the sound pressure level in the ear canal cavity 131 as a part of testing the hearing acuity of the user as well as confirming the integrity of the acoustic seal and the working condition of the earpiece 100. In one arrangement, the ASM 111 is housed in the assembly 113 to monitor sound pressure at the entrance to the occluded or partially occluded ear canal. All transducers shown can receive and/or transmit audio signals to a processor 121 that undertakes audio signal processing and provides a transceiver for audio via the wired or wireless communication path 119. Note in some exemplary embodiments the processor 121 can lie outside the assembly 113, and the audio signals can be transmitted via a wired (119) or wireless connection.

The earpiece 100 can actively monitor a sound pressure level both inside and outside an ear canal and enhance spatial and timbral sound quality while maintaining supervision to ensure safe sound reproduction levels. The earpiece 100 in various embodiments can conduct listening tests, filter sounds in the environment, monitor warning sounds in the environment, present notification based on identified warning sounds, maintain constant audio content to ambient sound levels, and filter sound in accordance with a Personalized Hearing Level (PHL).

The earpiece 100 can generate an Ear Canal Transfer Function (ECTF) to model the ear canal 131 using ECR 125 and ECM 123, as well as an Outer Ear Canal Transfer function (OETF) using ASM 111. For instance, the ECR 125 can deliver an impulse within the ear canal and generate the ECTF via cross correlation of the impulse with the impulse response of the ear canal. The earpiece 100 can also determine a sealing profile with the user's ear to compensate for any leakage. It also includes a Sound Pressure Level Dosimeter to estimate sound exposure and recovery times. This permits the earpiece 100 to safely administer and monitor sound exposure to the ear.

Referring to FIG. 2, a block diagram 200 of the earpiece 100 in accordance with an exemplary embodiment is shown. As illustrated, the earpiece 100 can include the processor 121 operatively coupled to the ASM 111, ECR 125, and ECM 123 via one or more Analog to Digital Converters (ADC) 202 and Digital to Analog Converters (DAC) 203. The processor 121 can utilize computing technologies such as a microprocessor, Application Specific Integrated Chip (ASIC), and/or digital signal processor (DSP) with associated storage memory 208 such a Flash, ROM, RAM, SRAM, DRAM or other like technologies for storing data, and can implement other technologies for controlling operations of the earpiece device 100. The processor 121 can also include a clock to record a time stamp.

As illustrated, the earpiece 100 can include a voice operated control (VOX) module 201 to provide voice control to one or more subsystems, such as a voice recognition system, a voice dictation system, a voice recorder, or any other voice related processor. The VOX 201 can also serve as a switch to indicate to the subsystem a presence of spoken voice and a voice activity level of the spoken voice. The VOX 201 can be a hardware component implemented by discrete or analog electronic components or a software component. In one arrangement, the processor 121 can provide functionality of the VOX 201 by way of software, such as program code, assembly language, or machine language.

The memory 208 can also store program instructions for execution on the processor 206 as well as captured audio processing data. For instance, memory 208 can be off-chip and external to the processor 208, and include a data buffer to temporarily capture the ambient sound and the internal sound, and a storage memory to save from the data buffer the recent portion of the history in a compressed format responsive to a directive by the processor. The data buffer can be a circular buffer that temporarily stores audio sound at a current time point to a previous time point. It should also be noted that the data buffer can in one configuration reside on the processor 121 to provide high speed data access. The storage memory can be non-volatile memory such as SRAM to store captured or compressed audio data.

The earpiece 100 can include an audio interface 212 operatively coupled to the processor 121 and VOX 201 to receive audio content, for example from a media player, cell phone, or any other communication device, and deliver the audio content to the processor 121. The processor 121 responsive to detecting voice operated events from the VOX 201 can adjust the audio content delivered to the ear canal. For instance, the processor 121 (or VOX 201) can lower a volume of the audio content responsive to detecting an event for transmitting the acute sound to the ear canal. The processor 121 by way of the ECM 123 can also actively monitor the sound exposure level inside the ear canal and adjust the audio to within a safe and subjectively optimized listening level range based on voice operating decisions made by the VOX 201.

The earpiece 100 can further include a transceiver 204 that can support singly or in combination any number of wireless access technologies including without limitation Bluetooth™, Wireless Fidelity (WiFi), Worldwide Interoperability for Microwave Access (WiMAX), and/or other short or long range communication protocols. The transceiver 204 can also provide support for dynamic downloading over-the-air to the earpiece 100. It should be noted also that next generation access technologies can also be applied to the present disclosure.

The location receiver 232 can utilize common technology such as a common GPS (Global Positioning System) receiver that can intercept satellite signals and therefrom determine a location fix of the earpiece 100.

The power supply 210 can utilize common power management technologies such as replaceable batteries, supply regulation technologies, and charging system technologies for supplying energy to the components of the earpiece 100 and to facilitate portable applications. A motor (not shown) can be a single supply motor driver coupled to the power supply 210 to improve sensory input via haptic vibration. As an example, the processor 121 can direct the motor to vibrate responsive to an action, such as a detection of a warning sound or an incoming voice call.

A visual display 206 (e.g., an LED light on the earpiece 100) informs both the Subscriber and other people of the operating status of the earpiece 100, e.g. if the user (i.e. Subscriber) is listening to a QuietCall. In an exemplary embodiment, the visual display 206 comprises colored lights on the earpiece 100. Note that in at least one exemplary embodiment the visual display 206 can be deactivated.

The earpiece 100 can further represent a single operational device or a family of devices configured in a master-slave arrangement, for example, a mobile device and an earpiece. In the latter embodiment, the components of the earpiece 100 can be reused in different form factors for the master and slave devices.

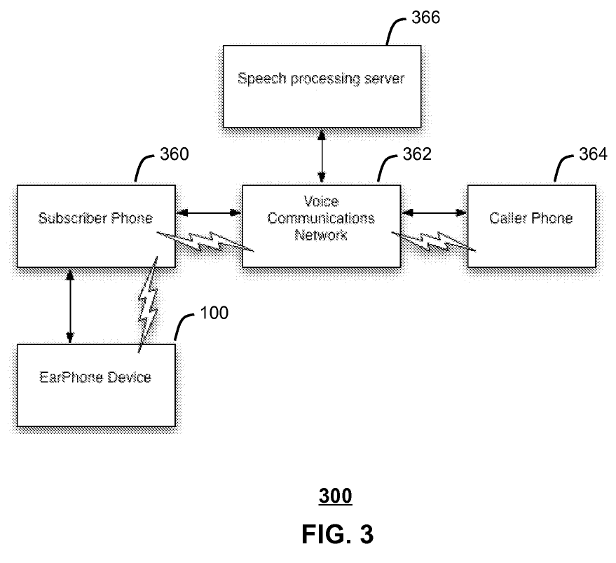

FIG. 3 illustrates a block diagram 300 for call control between the earpiece device 100 handled by the Subscriber and a caller phone 364 handled by the Caller. The Caller can communicate with the Subscriber via a conventional “land-line” wired phone or wireless mobile phone. The earpiece device 100 can be communicatively coupled to the subscriber phone 360 to permit the Subscriber to transmit subscriber response messages to the caller. The subscriber phone 360 can be a mobile communication device, such as a cell phone, that includes a keypad for allowing the Subscriber to type text messages responsive to an incoming call. The subscriber response message can be a text message, synthesized speech voice, or a pre-recorded utterance to the caller by way of keypad entry. In addition, a speech audio signal processing server 366 on a remote computer server can undertake speech-to-text and/or text-to-speech signal processing from audio signals generated by either the Subscriber or Caller, and can communicate processed data to either party. The data communication between the different devices can be by either wired or wireless communication.

The block diagram 300 illustrates system components for an exemplary call control scenario referred to as a “Quiet Call.” In Quiet Call a Called party (e.g., Subscriber) can respond to a calling party (e.g., Caller) using quiet non-speech sounds, or by responding to the calling party using a keypad or touch-sensitive interface on the mobile communication device. In other exemplary embodiments of the Quiet Call, an incoming call can be automatically accepted or rejected by the Subscriber depending on a number of factors, for instance, whether the caller is known to the QuietCall subscriber, whether the subscriber automatically accepts or rejects calls from a known subscriber when the QuietCall system is activated.

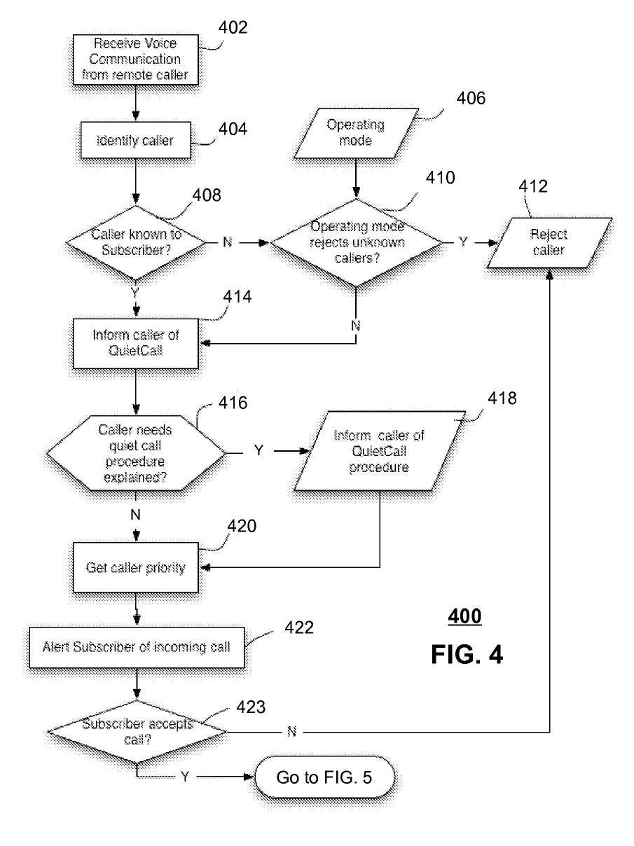

FIG. 4 is a flowchart for a method 400 to alert a subscriber of an incoming call in accordance with an exemplary embodiment of Quiet Call. The method 400 can be practiced with more or less than the number of steps shown and is not limited to the order shown. To describe the method 400, reference will be made to FIGS. 2 and 3, although it is understood that the method 400 can be implemented in any other manner using other suitable components. The method 400 can be implemented in a single earpiece, a pair of earpieces, headphones, or other suitable headset audio delivery device.

In response to receiving an incoming call at step 402 from a Caller that is directed to the User (i.e. Subscriber), an identification step resulting in a Caller ID is activated at step 404. The Caller ID identifies the Caller using a database that matches the Caller's phone number with a name. (This database can reside in electronic readable memory on the Subscriber's mobile phone, or on a remote server.) If at step 408 the Caller ID is not known to the Subscriber, then a second decision metric is activated at step 410.

Whether the Subscriber knows the Caller can be determined using a number of methods. One such exemplary method is to determine the Caller's phone number from one of the Subscriber's phone databases. Another method is to determine if the Caller's phone number has been used to receive or send any communication (i.e. voice or text or otherwise) from the Caller's mobile phone.

The second decision metric at step 410 determines whether to automatically reject the Caller's call to the Subscriber (i.e. without necessarily immediately informing the Subscriber that the Caller has called). If the Caller is rejected, then the Caller is informed 412 that the Subscriber (i.e. that person who the Caller is calling) cannot be reached (note that other messages can be used), for example using a prerecorded voice message. The second decision metric at step 410 can be configured manually or automatically when selecting the operating mode at step 406.

If the call is accepted, then the Caller can be informed that a QuietCall has been established at step 414. For instance, a voice message can be played to the Caller to let them know that the Subscriber has entered Quiet Call. If (416) a Caller needs a quiet call procedure then at step 418 the Caller can be informed of a Quiet Call procedure. Moreover, the Caller can be asked if they would like details of the procedure for taking part in a QuietCall, such as with an automatically generated speech prompt that says “You are taking part in a QuietCall. If you are unfamiliar with the procedure for taking part in a QuietCall, please press 1, otherwise press 9 or hang-up to terminate this call.” The QuietCall procedure can be explained either with a pre-recorded voice message, or with another message such as a text message sent via email or SMS to the Caller to remind the Caller of the procedure.

At step 420 a priority of the incoming call can be determined. The priority can be determined by prompting the Caller can to specify the importance of their call to the Subscriber. For instance, briefly referring back to FIG. 3, the earpiece 100 can direct the subscriber phone 360 to transmit a priority response request to the caller phone 364. The subscriber phone 360 can direct the caller phone 364 to generate a voice prompt when the Caller's call is accepted to request the priority level. The voice prompt can ask the Caller to specify the importance using the numeric keypad of their telephone, e.g. a rating of importance from 1-to-10. Depending on the particular operating configuration of the Subscribers phone, the Caller's call can be automatically rejected if the importance priority is below a Subscriber-defined or automatically defined value (e.g. 5 out of 10). In another arrangement, the Caller can speak a response that is converted to a numeric priority level.

At step 422, the Subscriber (i.e. User) can be alerted to the incoming call and the importance of the incoming call. An alert can comprises playing a name of the caller, for instance, by converting an address-book name of the caller to a speech message and reproducing the speech message, or converting a telephone number of the caller to a speech message and reproducing the speech message of the caller to the subscriber. Alternatively, the alert can play a ring-tone that has a different sound for different caller and/or priorities. In yet another exemplary embodiment, a call from a Caller can be automatically answered if the call importance is above a predetermined threshold, or if the Caller is a particular person who the Subscriber has identified.

In another embodiment, a “Whisper Caller ID” operating mode activates a messaging trigger whereby the name or telephone number of the Caller is reproduced as a sound message to alert the Subscriber of the incoming call. This can use a text-to-speech system that converts the Caller's name (e.g. as stored on the Subscriber's phone-book database) into a speech message, or it can reproduce pre-recorded audio messages, for instance, recorded by either the Subscriber or the Caller.

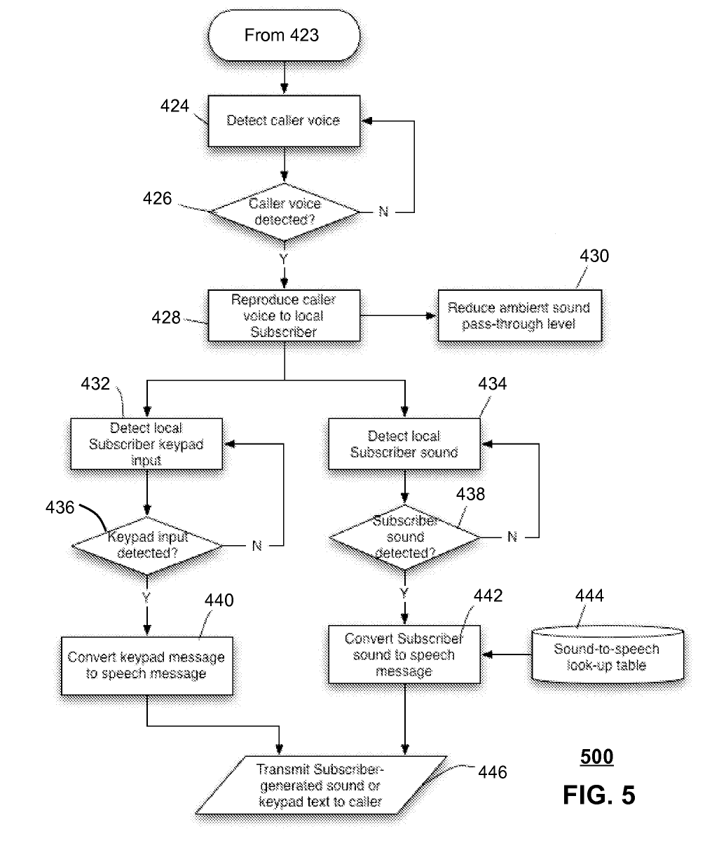

If at step 423 the Subscriber, or an automated mechanism, rejects the incoming call, the Caller can be informed that the call has been rejected at step 412. Alternatively, if the Subscriber accepts the incoming call, the Subscriber can respond to the caller communication via non-speech means as described ahead in FIG. 5.

FIG. 5 is a flowchart for a method to respond to a caller communication in accordance with an exemplary embodiment of Quiet Call. The method 500 can continue from step 423 of FIG. 4 and can be practiced with more or less than the number of steps shown. Method 500 is not limited to the order shown.

In at least one exemplary embodiment the method of 500 assumes that the incoming call from the Caller has been manually or automatically accepted by the Subscriber as described in Method 400. At step 424, the Caller's voice is detected, and if recognized at step 426, the Caller's voice is reproduced, for example by the ear-canal receiver (ECR) 125, and played locally to the Subscriber at step 428. For instance, upon the Caller receiving confirmation that Quiet Call has initiated and receiving a voice prompt requesting the Caller to state their name, the earpiece 100 by way of the ECR 125 can play the name to the Subscriber. This allows the Subscriber to hear who is calling without answering the call.

Prior to receiving the incoming the call, the earpiece 100 provides ambient sound transparency. That is, the earpiece 100 passes ambient sound from the environment to the user's ear canal 131 (see FIG. 1) so as to reproduce the environmental sounds within the ear canal. This alleviates the occlusion effect of the earpiece 100 if it partially occludes or fully occludes the ear canal 131. This allows the Subscriber to hear the sounds in his or her environment as though the earpiece 100 were absent. When an incoming call is accepted, the earpiece 100 however attenuates the ambient sound that is passed through to the ear canal to allow the Subscriber to listen to speech communication from the Caller. That is, when Caller voice is detected, the level of the ambient sound Pass-through is attenuated by process 430, by either a user-defined or pre-defined amount (e.g. 10 dB) to increase intelligibility of the Caller voice. In some embodiments, the ambient sound pass-through level is attenuated for the duration of the QuietCall, rather than being modulated only when Caller voice is detected. In practice, the processor 121 adjusts a gain of the ASM 111 ambient sound signal to attenuate the ambient sound level when the earpiece 100 plays speech communication from the Caller out of the ECR 125. The processor 121 can restore ambient transparency during periods of non-speech communication.

In one arrangement, exemplified in steps 432, 436, and 440, the Subscriber can respond to the Caller's speech communication using a keyboard (or key-pad, such as one built-in to a mobile phone). For instance, if a local subscriber keypad is detected at step 432, the Subscriber can compose and communicate a subscriber response message to the Caller. If keypad entry is detected at step 436, the text message can be converted to a speech message, for instance, by text-to-speech synthesis of the alphanumeric keys. The subscriber response message can be a text message, a synthesized speech voice, or a pre-recorded utterance that is then transmitted to the caller at step 446.

In another arrangement, exemplified in steps 434, 438, 442 and 444, the Subscriber can respond to the Caller's speech communication using non-speech sounds. For instance, the Ear Canal Microphone (ECM) 123 of the earpiece 100 can capture in the ear canal non-speech sounds such as a guttural noise, cough, tongue click, or teeth click. The processor 121 can then associate the non-speech sound with a call control, such as an automated reply, a call-back time, a busy status, a time-to-hold status, or a termination status. The non-speech sound can also be converted at step 442 to a speech message based on a sound-to-speech look-up at step 444. For instance, a teeth click can correspond to a “yes”, and a cough can correspond to a “no”. The call control can be embedded in a subscriber response message that is communicated to the Caller. This permits the Subscriber to enter a communication dialogue with the Caller in a subscriber non-speech mode. Accordingly, at step 446, the call control generated by the non-speech sounds can be transmitted to the Caller at step 440. The non-speech sounds created by the Subscriber can also be transmitted back to the Caller and decoded on the Caller phone.

Upon reviewing the aforementioned embodiments, it would be evident to an artisan with ordinary skill in the art that said embodiments can be modified, reduced, or enhanced without departing from the scope and spirit of the claims described below. For example, the Quiet Call can include a method wherein the Subscriber of the earpiece 100 is slowly acclimatized to the earpiece 100. In an initial stage, a pass-through (e.g., transmission) of the ASM signal to the ECR signal can be at a sound pressure level (SPL) that is substantially equivalent (within ±1 dB) to the SPL as would be obtained if the earpiece was not inserted in the ear of the Subscriber (e.g., transparent mode). In a second stage, the pass-through of the ASM signal to the ECR signal can be reduced; i.e. the SPL measured in the occluded ear canal is less than if the earpiece was not worn. The difference in SPL between the conditions when the earpiece is worn and when it is not worn can be between 5 and 10 dB. In a third stage, the pass-through transmission of the ASM signal to the ECR signal can be further reduced; i.e. the SPL measured in the occluded ear canal is less than if the earpiece was not worn. The difference in SPL between the conditions when the earphone device is worn and when it is not worn can be at least 10 dB. These different stages of acclimatization can be selected manually by the Subscriber, or automatically depending on how long the earpiece is worn. This time period can be determined automatically by analyzing how long the earpiece is active.

These are but a few examples of modifications that can be applied to the present disclosure without departing from the scope of the claims. Accordingly, the reader is directed to the claims section for a fuller understanding of the breadth and scope of the present disclosure.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system can also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not limited. Numerous modifications, changes, variations, substitutions and equivalents will occur to those skilled in the art without departing from the spirit and scope of the present embodiments of the invention as defined by the appended claims.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for call control suitable for use with an earpiece, the method comprising the steps of:
receiving an incoming call from a caller;
accepting the incoming call in a subscriber non-speech mode; and
communicating a subscriber generated response message to the caller, wherein the subscriber non-speech mode permits a non-spoken communication dialogue to the caller from a subscriber receiving the incoming call.

2. The method of claim 1, wherein the step of communicating a subscriber response message comprises at least one of sending a text message, synthesized speech voice, recorded output messages that have been previously generated by the subscriber, and a pre-recorded utterance to the caller by way of keypad entry.

3. The method of claim 1, wherein the step of communicating a subscriber response message comprises:
performing a call control responsive to detecting a non-speech sound, where the call control sends an automated reply, a call-back time, a busy status, a time-to-hold status, or a termination status.

4. The method of claim 1, comprising
alerting the subscriber to the incoming call; and
accepting or rejecting the incoming call based on at least one predetermined criteria.

5. The method of claim 4, wherein the at least one predetermined criteria is whether the subscriber and caller have previously made a telephone communication, or whether a particular operating mode is enabled to automatically answer the call from the caller.

6. The method of claim 4, wherein the at least one predetermined criteria is a caller identification number listed in a contact list, and accepting the incoming call if the caller identification number is in the contact list

7. The method of claim 4, further comprising
determining a priority of the incoming call; and
comparing the priority to a predetermined priority threshold for accepting the incoming call.

8. The method of claim 7, comprising requesting the caller to enter the priority in a numerical keypad to produce a priority level.

9. The method of claim 7, comprising requesting the caller to say a priority as a spoken utterance, and converting the spoken utterance to a priority level.

10. The method of claim 4, wherein the step of alerting the subscriber comprises converting an address-book name of the caller to a speech message and reproducing the speech message, or converting a telephone number of the caller to a speech message and reproducing the speech message of the caller to the subscriber.

11. The method of claim 10, wherein the name of the caller is obtained by comparing a caller Identification to a contact list, and synthesizing the name based on a recognized association of the caller identification to the name.

12. The method of claim 10, comprising prompting the caller for their name, recording the name, and playing the name to the subscriber.

13. The method of claim 10, comprising playing an audible ring-tone associated with the caller.

14. The method of claim 13, further comprising adjusting a volume, pitch, duration, or frequency content of the audible ring-tone based on a priority of the incoming call.

15. A method for call control suitable for use with an earpiece, the method comprising the steps of:
receiving an incoming call from a caller;
accepting the incoming call in a subscriber non-speech mode;
receiving and presenting speech communication from the caller; and
responding to the speech communication by way of non-spoken subscriber generated response messages,
wherein the subscriber non-speech mode permits a non-spoken communication dialogue from a subscriber receiving the incoming call and the caller.

16. The method of claim 15, further comprising alerting the subscriber to the incoming call; and
accepting the incoming call upon recognizing an identity or phone number of the caller, determining that the caller is in an approved contact list, or determining if the incoming call is a follow-up to a subscriber call.

17. The method of claim 15, further comprising detecting a caller message; and
alerting the subscriber to the caller message.

18. The method of claim 15, further comprising attenuating sound pass-through of the earpiece during an audible delivery of the speech communication.

19. The method of claim 15, further comprising providing a visual illumination to indicate that the subscriber is engaged in a quiet call.

20. An earpiece, comprising:
a microphone configured to capture sound;
a speaker to deliver sound to an ear canal; and
a processor operatively coupled to the microphone and the speaker, where the processor is configured to
analyze an incoming call from a caller; and
accept the incoming call in a subscriber non-speech mode; and
a transceiver operably coupled to the processor to
transmit the subscriber response message to the caller responsive to receiving the incoming call,
wherein the subscriber non-speech mode permits a non-spoken communication dialogue between the caller and a subscriber that receives the incoming call.

21. The earpiece of claim 20, wherein the processor sends a text message to the caller by way of keypad entry on a mobile device to permit the subscriber to respond to the caller without speaking.

22. The earpiece of claim 20, wherein the processor attenuates audio content playback that is music, voice mail, or voice messages when presenting speech communication from the caller.

23. The earpiece of claim 20, a text-to-speech module communicatively coupled to the processor to translate the subscriber response message to a synthesized voice message.

24. The earpiece of claim 20, wherein the microphone is an Ambient Sound Microphone (ASM) configured to capture ambient sound, and the processor responsive to accepting the incoming call limits ambient sound pass-through to the speaker.

25. The earpiece of claim 20, wherein the microphone is an Ear Canal Microphone (ECM) configured to capture internal non-speech sound in the ear canal, wherein the processor detects a non-speech sound from a subscriber, and associates the non-speech sound with a call control, where the non-speech sound is a guttural noise, cough, tongue click, or teeth click.
